(19) United States
(12) Patent Application Publication
(10) Pub. No.: US 2007/0124438 A1
(43) Pub. Date: May 31, 2007

(54) Method and system for providing service control and brokering in IMS-based telecommunication system

(75) Inventors: Hyun-Seo Park, Daejeon (KR); Sook-Yang Kang, Daejeon (KR); Gyung-Chul Sihn, Daejeon (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/493,907

(22) Filed: Jul. 27, 2006

(30) Foreign Application Priority Data
Nov. 28, 2005 (KR) 10-2005-0114161
Apr. 24, 2006 (KR) 10-2006-0036569

(51) Int. Cl. G06F 15/173

(52) U.S. Cl. 709/223

(57) ABSTRACT

The present invention relates to a service registration, control, and brokering method in an IMS-based communication system, and a system using the same. In the case that a user moving to a visited network from a home network wants to receive local service in the visited network, the user checks whether the user can receive the local service in the visited network through the home network. If it is possible, a serving call state control function (S-CSCF) that handles service control in the visited network performs local service control upon a user's request and provides the corresponding local service to the user. Accordingly, the user can be more efficiently provided with local services through the S-CSCF that handles the service control of the visited network. In addition, the visited network can provide the user with services that are adapted to a profile of the user.

### CROSS-REFERENCE TO RELATED APPLICATION

This application claims priority to and the benefits of Korean Patent Application Nos. 10-2005-0114161 and 10-2006-0036569 respectively filed in the Korean Intellectual Property Office on Nov. 28, 2005 and Apr. 24, 2006, the entire contents of which are incorporated herein by reference.

### BACKGROUND OF THE INVENTION

(a) Field of the Invention

The present invention relates to a communication system based on an Internet Protocol (IP) Multimedia Core Network Subsystem (IMS), and more particularly, relates to a method for registering, controlling, and brokering services in a visited network, and a system using the same.

(b) Description of the Related Art

In general, a user is always provided with services through a service control device such as a serving call state control function (S-CSCF) that handles service control of a home network even when the user moves from the home network to a visited network in an IMS-based communication system. Such a service control scheme has a drawback of providing services inefficiently.

That is, service control in the visited network always goes through the service control device in the home network, thereby causing triangle routing. Also, the service control in the visited network is handled by the service control device in the home network since the service control device in the home network selects a service control device in the visited network, and therefore it is difficult to efficiently provide local services to the user. Further, it is also difficult to provide local services adapted to the user since the visited network does not have a profile of the user.

In addition, service brokering should be performed on the basis of context information so as to provide a user roaming to the visited network with a service that is adapted to the context information. However, the service control of the home network according to the prior art cannot provide the user with services adapted to the context information.

The above information disclosed in this Background section is only for enhancement of understanding of the background of the invention and therefore it may contain information that does not form the prior art that is already known in this country to a person of ordinary skill in the art.

### SUMMARY OF THE INVENTION

Accordingly, the present invention has been made in an effort to provide a service control and service brokering method that enables a visited network to directly provide a user with local services rather than going through a home network in an IMS-based communication network, and a system using the same.

In addition, the present invention provides a service control and service brokering method that enables a visited network to provide a user with optimal services that are adapted to a profile of the user, and a system using the same.

In an Internet Protocol multimedia core network subsystem (IMS)-based communication system that includes a home network and a visited network, an exemplary service brokering system according to an embodiment of the present invention controls services through user equipment in the visited network when a user moves to the visited network from the home network. Herein, the service broker system is located in the visited network.

The service brokering system includes a proxy session control device, an interrogating session control device, and a visited-home network subscriber server. The proxy session control device performs as a contact point for the user equipment. The serving session control device controls a service to be provided to the user equipment. The interrogating session control device searches for a serving session control device that handles the service control upon a request of the proxy session control device. The visited-home network subscriber server receives user information and profiles of the user from the home network, and manages the information and the profiles.

An exemplary service registration and control method in an IP multimedia core network subsystem (IMS)-based communication system that includes a home network and a visited network according to an embodiment of the present invention performs service registration and control in the visited network by using user equipment. Herein, the service brokering system is a service brokering system located in the visited network.

The service registration and control method includes (a) the user equipment registering services to the home network with inclusion of a local service control request; (b) in the case that local service control is allowed to the user equipment, the user equipment receiving a service registration confirmation message that contains information on the allowance of the home network on the local service control; (c) after receiving the service registration confirmation message, the user equipment requesting local service registration to the service brokering system; and (d) the user equipment receiving a local service registration confirmation message from the service brokering system.

An exemplary service registration and control method in an IP multimedia core network subsystem (IMS)-based communication system that includes a home network and a visited network according to an embodiment of the present invention performs registration and control of a service to be provided to user equipment by using the service brokering system.

The service registration and control method includes (a) the service brokering system transmitting a service registration request message that is transmitted from the user equipment to the home network; (b) the service brokering system receiving a service registration confirmation message from the home network in response to the service registration request message, the information containing information on allowance of local service control; (c) in the case that the user equipment service requests local service control, the service brokering system registering the user equipment as user equipment to be receiving local services; and (d) the service brokering system providing services to the registered user equipment.

### BRIEF DESCRIPTION OF THE DRAWINGS

FIG. 1 is a configuration diagram of a service network where an S-CSCF in a visited network performs service control via an S-CSCF in a home network in a typical IMS-based communication system.

FIG. 2 is a configuration diagram of a service network that performs service control and service brokering in a visited network according to an exemplary embodiment of the present invention.

FIG. 3 is a flowchart of a service registration process for a subscriber according to an exemplary embodiment of the present invention.

FIG. 4 is a flowchart showing service control and service brokering methods of a home network upon a subscriber's service request according to an exemplary embodiment of the present invention.

FIG. 5 is a flowchart showing service control and service brokering methods of a visited network upon a subscriber's service request according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, throughout this specification and the claims which follow, unless explicitly described to the contrary, the word “comprise/include” or variations such as “comprises/includes” or “comprising/including” will be understood to imply the inclusion of stated elements but not the exclusion of any other elements.

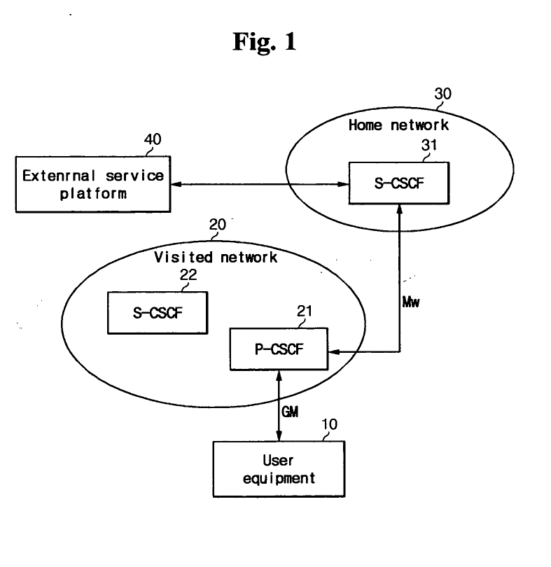

An Internet Protocol multimedia subsystem (IMS)-based communication system controls multimedia services and performs service brokering as shown in FIG. 1.

FIG. 1 illustrates a service network structure in which a serving call state control function (S-CSCF) in a visited network performs service control via an S-CSCF in a home network in a typical IMS-based communication system.

In FIG. 1, when user equipment (UE) 10 moves to a visited network 20 from a home network 30, the UE 10 is connected to a proxy call state control function (P-CSCF) 21 located in the visited network 20 and that is provided with services. At this time, the UE 10 transmits a message that contains a uniform resource identifier (URI) to the visited network 20, wherein the URI is a message header indicating that local service control is requested.

Upon the service control request from the UE 10, the P-CSCF 21 in the visited network 20 requests service control to an S-CSCF 31 that handles service control of the home network 30. Then the S-CSCF 31 transmits a service control message to an external service platform 40. At this time, the external service platform 40 checks whether the S-SCSF 31 accepts the user-requested local service control.

In the case that the acceptance of the local service control is confirmed, the S-CSCF 31 in the home network 30 transmits a message to the S-CSCF 22 in the visited network 20 to request the local service control, and the S-CSCF 22 handling service control of the visited network 20 performs the local service control. In addition, the S-CSCF 31 in the home network 30 transmits a service control message to the S-CSCF 22 handling the service control of the visited network 20 and provides local services.

In such an IMS-based communication system, a user is always provided with services via an S-CSCF in a home network even though the user is roaming from the home network to a visited network. In addition, the user cannot be provided with appropriate local services from the visited network since the visited network does not have a profile of the user.

Therefore, a method and a system for service control and service brokering according to an exemplary embodiment of the present invention can efficiently offer services.

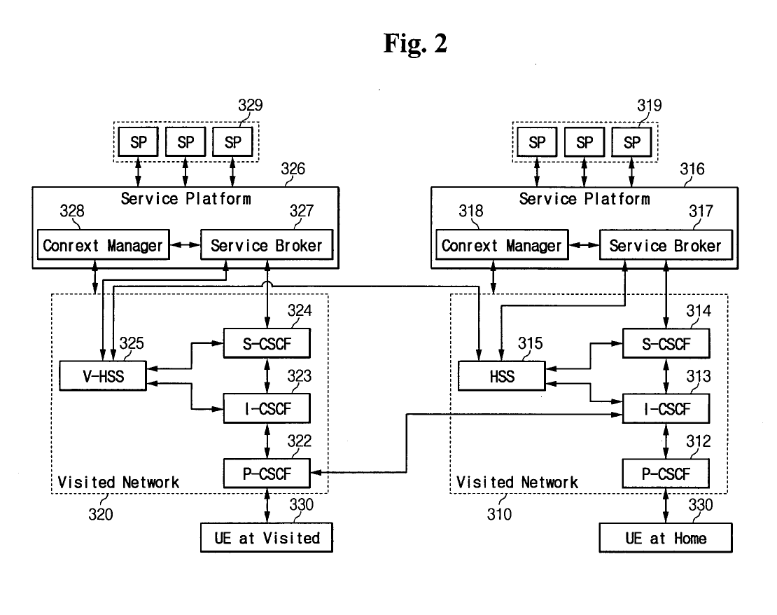

FIG. 2 is a configuration diagram of a system that performs service control and service brokering in the IMS-based communication system according to an exemplary embodiment of the present invention.

As shown in FIG. 2, in the IMS-based communication system, user equipment (UE) 330 can still be provided with the same service that the UE 330 was previously provided in a home network 310 even after the UE 310 moves to a visited network 320. The system according to the exemplary embodiment of the present invention performs service control and service brokering in order to provide the same service to the UE 330 in the visited network 320.

For this purpose, the system according to the exemplary embodiment of the present invention includes a P-CSCF 322, an interrogation call session control function (I-CSCF) 323, an S-CSCF 324, and a visited-home subscriber server (V-HSS) 325, and is connected to a service provider (SP) 329 through a service platform 326. Hereinafter, the system in the present embodiment will be called a service brokering system. Since the service brokering system is a part of the visited network 320, the visited network 320 will be hereinafter understood as the service brokering system for better comprehension and ease of description.

With such a configuration, the visited network 320 is connected to the home network 310 and performs service control and service brokering.

The home network 310 also includes an S-CSCF 314, an I-CSCF 313, a P-CSCF 312, and an HSS 315 in order to provide services to the UE 10, and is connected to the SP 319 through a service platform 316.

In each network, the P-CSCFs 312 and 322, which are the first contact points within the IMS for the user, register user information from the visited network 320 to the home network 310 and forward a transmitting/receiving call request to the home network 310. That is, the UE 330 located in the home network 310 requests a service from the P-CSCF 312 in the home network.

Herein, the UE 330 may be provided as a mobile terminal (MT) that performs radio transmission and radio transmission-related functions, terminal equipment (TE), or a communication terminal that performs a terminal adaptation function (TAF). In this case, the UE 330 communicates with the P-CSCFs 312 and 322 using a session initiation protocol (SIP).

The I-CSCFs 313 and 323 select an S-CSCF that is appropriate for the user's call request from a plurality of S-CSCFs, and hide configuration information on the S-CSCF 314 in the home network 310 from other networks for the purpose of security. The I-CSCF 313 receives a message from the P-CSCFs 312 and 322 that have received a service request, searches for a correct S-CSCF 314 from the HSS 315, and transmits a response message to the P-CSCF 312.

At this time, the P-CSCFs 312 and 322 communicate with the I-CSCFs 313 and 323 using the SIP, and the I-CSCFs 313 and 323 communicate with the S-CSCFs 314 and 324 using the SIP. On the other hand, the I-CSCF 313 communicates with the HSS 315 using a diameter protocol. Herein, the diameter protocol is an IETF standard protocol that has been developed for the next generation portable Internet and a roaming network, and is utilized for authorization system development in the next generation network such as a public wireless local area network, a portable Internet, and a wideband convergence network.

The S-CSCFs 314 and 324 handle service control for a user in an IMS network. That is, the S-CSCFs 314 and 324 registers with the HSS 315 as servers controlling sessions of the UE 330 and download and stores registration information of the user. The S-CSCFs 314 and 324 handle call/sessions of a registered user and control services. Also, S-CSCFs 314 and 324 provide service resource-related information to the user.

The HSS 315 is a database of all users, and manages user profiles and a physical location of the user and performs authorization and authentication of the user. That is, the HSS 315 stores information on all users in the IMS network, and communicates with the S-CSCF 314 using the diameter protocol.

The service platforms 316 and 326 deliver services provided from the SPs 319 and 329 to the IMS network, and include context managers 318 and 328 and service brokers 317 and 327. The context managers 318 and 328 manage context information that is required for providing a context-adapted service to a user in the visited network 320. Herein, the context information is data collected by continuously monitoring a current condition of the user, particularly a condition of a visited network, so as to adapt services to a user's current circumstance and select and access an optimal network.

The service brokers 317 and 327 perform service brokering, and are capable of providing a service that is adapted to a user's profile based on the user's information that has been provided during registration. That is, the service brokers 317 and 327 adapt services to be offered to the user service device on the basis of the context information collected by the context managers 318 and 328 and the profile of the user.

The SPs 319 and 328 implement services through a service application program interface (API) provided by the service platforms 316 and 326, and provide the services to the UE 330.

A configuration in the visited network 320 for providing services to the UE 330 will now be described, wherein the configuration includes the above-described constituent elements.

The visited network 320 has constituent elements that are similar to those of the previously described home network 310. However, additional constituent elements are required to provide a local service to the UE 330 located in the visited network 320.

The P-CSCF 322 transmits a service request message to the I-CSCF 313 in the home network 310 and the I-CSCF 323 in the visited network 320 in order to search for a correct S-CSCF 314 that handles service control of the home network 310. Herein, the I-CSCF 323 searches for an S-CSCF 324 from the V-HSS 325 and transmits the search result to the P-CSCF 322.

The V-HSS 325 functions the same as the HSS 315 in the home network 310. In addition, in the case that the user is roaming to the visited network 320, the V-HSS 325 receives information on the user from the HSS 315 in the home network and manages the information.

Based on such a structure, a service providing method according to an exemplary embodiment of the present invention will now be described. Particularly, a method for service control and service brokering in the visited network will be described in more detail with the case that the user is roaming from the home network 310 to the visited network 320.

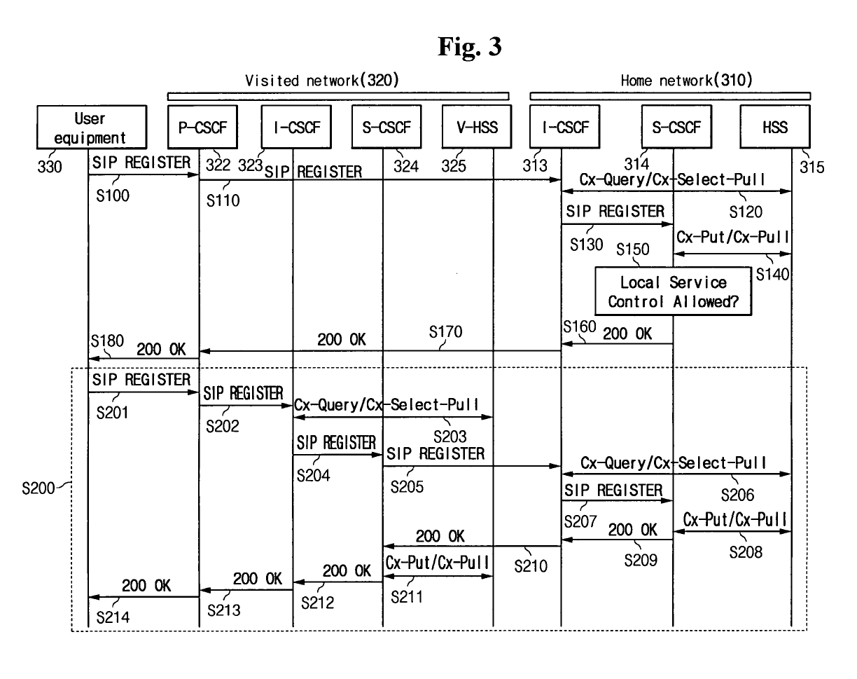

Through a network that is capable of performing the service control and service brokering shown in FIG. 2, a user service registration process will be described with reference to FIG. 3.

FIG. 3 is a flowchart showing a service registration process of a user according to an exemplary embodiment of the present invention.

As shown in FIG. 3, the user having moved to the visited network 320 requests service registration to the P-SCSF 322 using the UE 330 in order to receive services from the visited network 320 in step S100. Accordingly, the UE 330 transmits a first SIP register message (also called a service registration request message) to the P-CSCF 322 in the visited network 320 in step S100.

The first SIP register message is used for registering service preference information to a P-CSCF 322 in a new visited network in order to receive a user-preferred service. At this time, the first SIP register message contains information about whether the user requested local service control is included in the message and an inquiry on whether the visited network is capable of performing local service control.

The P-CSCF 322 of the visited network 320 transmits the first SIP register message to the I-CSCF 313 in the home network 310 in order to transmit the message to the S-CSCF 314 that handles service control of the home network 310, in step S110. In order to search for the S-CSCF 314 to which the user information is registered from among a plurality of S-CSCFs in the home network 310, the P-SCSF 322 in the visited network 320 transmits the first SIP register message to the I-SCSF 313 that directly communicates with the S-CSCF 314 using the SIP.

The I-CSCF 313 in the home network 310 queries the HSS 315 to search for the S-CSCF 314 that controls user-wanted services in step S120. That is, the I-CSCF 313 transmits a query language to the HSS 315 to search for the S-CSCF 314. When the S-CSCF 314 is searched, the I-CSCF 313 transmits the first SIP register message that has been transmitted from the visited network 320 to the searched S-CSCF 314 in step S130.

After receiving the first register message, the S-CSCF 314 registers the user and updates user information to the HSS 315 in step S140. At this time, the S-CSCF 314 determines whether the visited network 320 is capable of performing local service control in step S150. In the case that information on capabilities of performing a local service control of a plurality of visited networks are predetermined by policy and stored in the S-CSCF 314 of the home network 310, whether the visited network 320 is capable of performing a local service control can also be determined by searching for the corresponding information from the S-CSCF 314 in the home network, but it is not restrictive.

In the case that the visited network 320 is capable of performing the local service control and the first SIP register message contains a user's request on the local service control, the S-CSCF 314 in the home network 310 transmits a registration result to the I-CSCF 313 by sending a SIP 200 OK message (also called a service registration confirm message) thereto in step S160. The SIP 200 OK message is transmitted to the P-CSCF 322 in the visited network 320 through the I-CSCF 313 in the home network 310 in step S170, and is then transmitted to the UE 330 in step S180. Herein, the 200 OK message is a response message informing that the SIP message has been successfully received.

In the case that a result of the determination of the capability of performing the local service control in the step S150 shows that the visited network 320 is not capable of performing the local service control, the user registration process is terminated in step S180. However, in the case that a user located in the visited network 320 requests local service control and the S-CSCF 314 located therein allows the local service control, local service registration is additionally performed through processes in a block of S200 in FIG. 3. The local service registration process means that a user having entered the visited network 320 registers with the S-CSCF 324 in the visited network 320 through the user's UE 330 so as to receive services through the UE 330.

In the local service registration process, the UE 330 firstly transmits a second SIP register message (also called a local service registration request message) to the P-CSCF 322 in the visited network 320 in step S201. The P-CSCF 322 transmits the second SIP register message to the I-CSCF 323 in the visited network 320 in order to forward the second SIP register message to the S-CSCF 324 that handles service control for the user in the visited network 32 in step S202.

The I-CSCF 323 queries the V-HSS 325 in order to search for the S-CSCF 324 that directly control services requested by the user among a plurality of S-CSCFs in step S203. The I-CSCF 323 transmits the second SIP message to the searched S-CSCF 324 in step S204. After receiving the second SIP register message, the S-CSCF 324 forwards the second SIP register message to the I-CSCF in the home network 310 in order to inform the local service registration in step S205. Thus, the second SIP message that contains information on the user local service registration is forwarded to the S-CSCF 314 in the home network 310 from the S-SCSF 324 in the visited network 320 in step S205.

The I-CSCF 313 in the home network 310 queries the HSS 315 to search for the S-CSCF 314 that performs service control for the user in step S206, and forwards the second SIP register message to the searched S-CSCF 314 in step S207. After receiving the second SIP register message, the S-CSCF 314 registers local services for the user and updates the user information to the HSS 315 in step S208.

The S-CSCF 314 transmits a result of the service registration using a SIP OK message (also called a local service registration confirmation message) in response to the second SIP register message in step S209. Then the SIP OK message is transmitted to the S-CSCF 324 in the visited network through the I-CSCF 313 in the home network 310 in step S210. After updating user information to the V-HSS 325 based on the SIP 200 OK message in step S211, the S-CSCF 324 transmits the SIP OK message transmitted from the home network 310 to the I-CSCF 323 in step S212. The I-CSCF 323 forwards the SIP 200 OK message from the S-CSCF 323 to the P-CSCF 322 and the P-CSCF 322 transmits the message to the UE 330, and the service registration process for the user who requested the local service control is terminated.

The following will describe a process for providing services to the user who has completed service registration in the home network 310 in the case that the visited network 320 is incapable of performing local service control or the case that the visited network 320 is capable of performing the local service control.

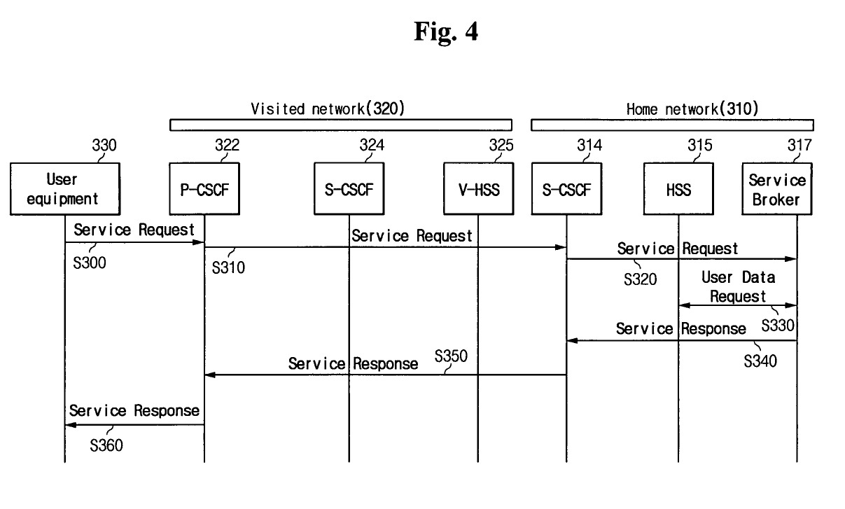

FIG. 4 is a flowchart showing a method for service control and service brokering in a home network upon a user's service request according to an exemplary embodiment of the present invention.

As shown in FIG. 4, a user roaming from the home network 310 to the visited network 320 requests services through the UE 330. At this time, the UE 330 transmits a service request message to the P-CSCF 322 located in the visited network 320 in the case that the service requested by the user requires service control of the home network 310 in step S300.

Since a routing path of the service request message is set to go through the S-CSCF 314 in the home network 310, the P-CSCF 322 transmits the service request message to the S-CSCF 314 that handles service control in the home network 310 of the user in step S310. The service request message contains the message routing path and information on whether the service requested from the user through the UE 330 requires service control of the home network 310 or service control of the visited network 320.

Upon the user's service request, the S-CSCF 314 in the home network 310 forwards the service request message to the service broker 317 in step S320. The service broker 317 requests a user profile from the HSS 315 in order to provide an optimal service to the user who requested the service in step S330.

After receiving the user profile from the HSS 315, the service broker 317 transmits a service response message to the S-CSCF 14 to provide a service adapted to the user profile in step S340. The S-CSCF 314 in the home network 310 forwards the service response message to the P-CSCF 322 in the visited network 320 in step S350, and then the service response message is transmitted to the UE 300 in step S360.

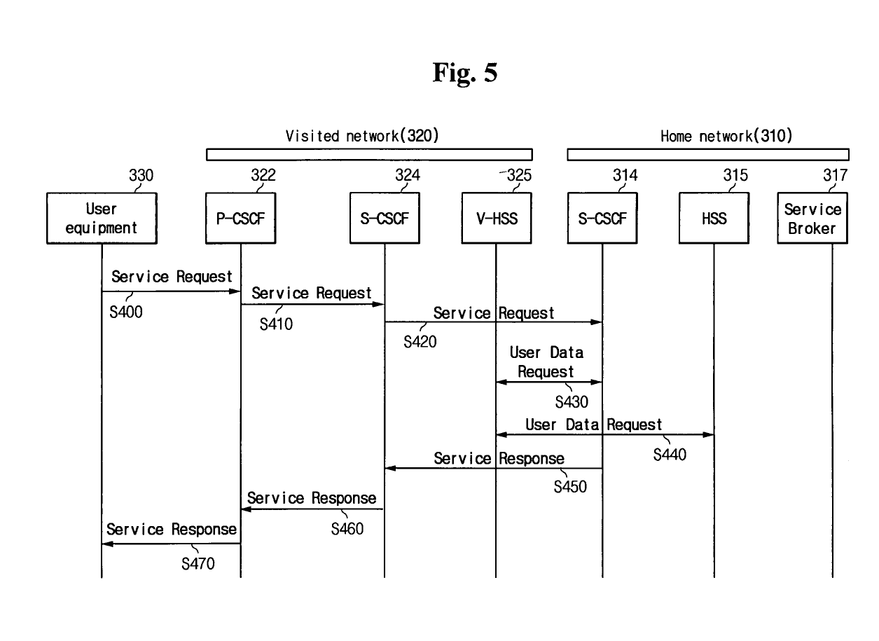

In the case that the visited network 320 is capable of performing the local service control, a process for providing a user with the same service that the user previously received in the home network 310 in the visited network 320 will now be described with reference to FIG. 5.

FIG. 5 is a flowchart showing a method for service control and service brokering according to a user's service request according to an exemplary embodiment of the present invention.

As shown in FIG. 5, a user located in the visited network 320 requests a service that requires local service control and is provided with the service through the process of FIG. 5. First, the user requests a service through the UE 330, and then the UE 330 transmits a service request message to the P-CSCF 322 in the visited network in step S400. At this time, since the service request message is set to be transmitted via the S-CSCF 324 in the visited network 320 according to a routing path contained in the service request message, the P-CSCF 322 transmits the service request message to the S-CSCF 324 that handles service control of the visited network 320 in step S410.

The S-CSCF 324 in the visited network 320 transmits the service request message to the service broker 327 so as to provide a service adapted to the user in step S420. The service broker 327 requests user profiles from the V-HSS 325 to search for a profile of the user who has requested the service, in step S430. At this time, the service broker 327 may request the profile of the user from the HSS 315 in the home network 310 in the case that the profile is not stored in the V-HSS 325, in step S440.

The service broker 327 transmits a service response message in response to the S-SCSF 324 request message to provide a service adapted to the user profile that has been provided from the HSS 315 in step S450. The S-CSCF 324 in the visited network 320 transmits the service response message to the P-CSCF 322 in the visited network 320 in step S460, and the service response message is transmitted to the UE 330 in step S470 so that the user can be provided with the requested services through the UE 330.

The method for service control and service brokering of the visited network 320 of FIG. 5 is performed only when the local service control is permitted by the UE 300. In the case that the UE 330 does not permit the local service control, the user in the visited network is provided with services from the home network 310 according to a typical method.

Herein, a program realizing functionalities that correspond to the configuration according to the above-described exemplary embodiment of the present invention or a recording medium in which the program is installed are also included in the scope of the present invention.

According to the above-described exemplary embodiment, the service control and service routing method can solve a triangle routing problem of providing services to a user in a visited network through an S-CSCF in the home network, and a service that is adapted to context information in the visited network can be provided to the user.

In addition, the user can receive services adapted to a profile and environment of the user, and a service provider can efficiently provide local services to a user in a visited network, thereby creating a source of profit.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. In an Internet Protocol multimedia core network subsystem (IMS)-based communication system that includes a home network and a visited network, a service brokering system for controlling services through user equipment in the visited network when a user moves to the visited network from the home network, wherein the service brokering system refers to a service brokering system located in the visited network, the service brokering system comprising:
a proxy session control device for performing as a contact point for the user equipment;
a serving session control device for controlling a service to be provided to the user equipment;
an interrogating session control device for searching for a serving session control device that controls the service upon a request of the proxy session control device; and
a visited-home network subscriber server for receiving and managing user information and profiles of the user from the home network,
wherein the proxy session control device transmits a message informing that services are provided to the user equipment based on the user information and the profile according to a control of the serving session control device.

2. The service brokering system of claim 1, further comprising a service platform for receiving the user information and profiles from the visited-home network subscriber server, performing service brokering in order to provide user-adapted services to the user, and managing context information.

3. The service brokering system of claim 2, wherein the service platform comprises:
a context manager for managing context information that is required for providing services that are adapted to the context information on the user to the user equipment; and
a service broker for adapting services to be provided to the user equipment to context information collected by the context manager and the profile of the user.

4. The service brokering system of claim 1, wherein the home network comprises:
when the user wants to be provided with services that require service control of the home network,
a serving session control device for determining whether the service brokering system is a system that allows local service control and transmitting a result of the determination to the proxy session control device; and
a home network subscriber server for managing user information and profiles of a user of the user equipment, and providing the user information and the profile to the visited-home network subscriber server.

5. A service registration and control method using user equipment in an IP multimedia core network subsystem (IMS)-based communication system that includes a home network and a service brokering system, the service brokering system located in a visited network, the method comprising:
(a) the user equipment registering services to the home network with inclusion of a local service control request;
(b) when local service control is allowed to the user equipment, the user equipment receiving a service registration confirmation message that contains information on the allowance on the local service control from the home network;
(c) after receiving the service registration confirmation message, the user equipment requesting local service registration to the service brokering system; and
(d) the user equipment receiving a local service registration confirmation message from the service brokering system.

6. The service registration and control method of claim 5, wherein, when the user equipment receives services controlled by the home network, the service registration and control method further comprises:
the user equipment transmitting a service request message to the home network; and
the user equipment receiving a service that is adapted to a profile of a user of the user equipment from the home network on the basis of the service request message.

7. The service registration and control method of claim 5, wherein the service brokering system transmits a local service registration request message to the home network and receives a user profile from the home network.

8. The service registration and control method of claim 7, wherein, when the user equipment receives a service controlled by the service brokering system, the service registration and control method further comprises:
the user equipment transmitting a service request message to the service brokering system; and
the user equipment receiving a service that is adapted to a user profile of the user equipment on the basis of the service request message from the service brokering system.

9. The service registration and control method of claim 7, wherein the user profile includes a user profile that is transmitted from the home network and stored in the service brokering system and a user profile stored in the home network and provided to the service brokering system upon a request of the service brokering system.

10. The service registration and control method of claim 6, wherein the service request message contains service routing path information that includes information on one of a serving session control device of the home network and a service session control device of the service brokering system, wherein the home network and the service brokering system control services to be provided to the user equipment.

11. The service registration and control method of claim 5, wherein the service registration request message contains information on a request for inquiring whether the service brokering system allows local services, information on whether the user equipment requests local service control, and a service routing path of one of the home network and the service brokering system, wherein the home network and the service brokering system control the services.

12. A method for registering and controlling services to be provided to user equipment by using a service brokering system in an IP multimedia core network subsystem (IMS)-based communication system that includes a home network and a service brokering system, the service brokering system located in a visited network, the method comprising:
(a) the service brokering system transmitting a service registration request message that is transmitted from the user equipment to the home network;
(b) the service brokering system receiving a service registration confirmation message from the home network in response to the service registration request message, the message containing information on allowance of local service control;
(c) when the user equipment service requests local service control, the service brokering system registering the user equipment as user equipment for receiving local services; and
(d) the service brokering system providing services to the registered user equipment.

13. The method of claim 12, wherein (c) comprises:
receiving a local service registration request message that requests registration of the user equipment as a device to which a local service is provided;
the service brokering system transmitting the local service registration request message to the home network and informing that the user equipment is registered as the device to which the local service is provided;
receiving a local service registration confirmation message from the home network, wherein the local service registration confirmation message contains an updated profile of the user and a local service registration result; and
the service brokering system transmitting the local service registration confirmation message to the user equipment.

14. The method of claim 12, wherein (d) comprises:
(i) setting a routing path of a service to be provided to the user equipment based on a routing path included in the service registration request message; and
(ii) after setting the routing path, providing a service response message to the user equipment, wherein the service response message includes services that are adapted to the user profile.

15. The method of claim 14, wherein, in (ii), the service brokering system performs a profile update with the user profile provided from the home network.

16. The method of claim 12, when the service brokering system does not allow local service for the service to be provided to the user equipment in (a), further comprising:
the service brokering system transmitting the service request message to the home network;
receiving a service response message generated from the home network, wherein the service response message includes a service adapted to the user profile; and
the service brokering system transmitting the service response message to the user equipment.

17. The method of claim 12, when the user equipment does not request local service control in (b), further comprising:
the service brokering system transmitting a service registration request message to the home network in order to receive the service through the home network;
receiving a service registration confirmation message from a home network with which the user equipment is registered; and
the brokering system receiving the services from the home network and transmitting the services to the user equipment.
